(19) United States
(12) Patent Application Publication
(10) Pub. No.: US 2006/0266131 A1
(43) Pub. Date: Nov. 30, 2006

(54) Sampling tool

(76) Inventor: Donald Michael Graham, Hamilton (NZ)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/543,783

(22) PCT Filed: Jan. 29, 2004
(86) PCT No.: PCT/NZ04/00011

§ 371 Date: Jun. 5, 2006

(30) Foreign Application Priority Data
Jan. 29, 2003 (NZ) 523885

(51) Int. Cl. G01N 1/04

(52) U.S. Cl. 73/864.44

(57) ABSTRACT

A sampling tool (1) including a tool head (3) with a sample retaining portion (5) characterised in that said sampling tool (1) further includes a fluid conduit (6) extending from the sample-retaining portion (5) through the tool head (3), and a method of obtaining a sample (11) using said sampling tool (1), said method including the steps of inserting said tool head (3) into a test material (12); extraction of said tool head (3) from the test material (12) together with a sample (11) of said material (12) retained in said sample retaining portion (5); characterised in that; an elevated pressure is applied via said fluid conduit (6) to said sample-retaining portion (5) to expel said sample (11).

### TECHNICAL FIELD

The present invention relates to a sampling tool and a method of using same for use in removing smaller sample portions from larger objects for substances for testing. In particular, the present invention is particularly suited for use in extracting organic samples such as meat and the like.

### BACKGROUND ART

It is necessary to remove small sample portions of meat, cheese, and other organic matter for a variety of tests before the produce reaches domestic consumption. If the produce is destined for export or other high cost activities, it is further desirable to identify and reject any contaminated or low quality produce before transportation occurs.

To enable accurate testing procedures to be performed without bias from the effects of surface contamination and atmospheric effects, a sample must be retrieved from the central body of the material.

Conventional techniques for achieving this end utilise a shaped hollow conical cutter element located on the tip of an elongated rod and handle. The conical cutter is attached to the rod at a point about its circumference of the laterally enlarged end. A sample of meat (for example) is retrieved by inserting the apex of the conical cutter into the meat until embedded in the meat block at a given depth. Typically, this depth ensures the whole of the conical cutter is enclosed inside the meat block and is located at a depth deemed sufficient to retrieve a true indication of the meat condition.

The sampler is then extracted from the meat block in the reciprocal direction to the insertion, thereby scooping meat into the inner conical recess of the cutter for retrieval and testing. Typically, the circular edge of the conical element is sharpened to aid severing of the meat fibres and to ensure ease of extraction/cutting as the sampler is removed from the sample body.

However, with existing samplers, there remains the difficulty of extracting the sample from the conical recess. Firstly the sample volume is relatively small and this complicates manual removal without a degree of dexterity. Furthermore, unless some further form of instrument such as tweezers, forceps and so forth is used to aid extraction, there is further risk of contamination of the sample by the operator's fingers. Many samples such as meat are relatively fibrous and/or sticky further hindering the removal of the sample from the conical cutter.

Whilst all these difficulties may be overcome in time, it is clearly desirable for an operator to perform this operation without undue delay and with repeatability and efficiency.

Prior art in this general field includes the following:

U.S. Pat. No. 5,741,177 Roberts et al: One aspect of Roberts discloses a muscle tissue sampling device. However, there is no disclosure of an aid to dislodge the retrieved sample from the sampling device.

WO98/34107 Morning Star Diagnostic Inc: Morning Star teaches of a meat extractor formed as a partially hollow cylinder with a series of serrated teeth at one end that cut and temporarily hold a piece of severed meat within the cylinder. There is no disclosure of an aid to dislodge the retrieved sample from the sampling device.

U.S. Pat. No. 5,413,526 Abler: Abler is not directly related to retrieving core samples and instead uses a device to insert solid coolant charges into portions of an animal carcass to aid in the development of pale and soft meat tissue. The tool for inserting the frozen charges (such as solid carbon dioxide or dry ice) uses a spear blade at the leading edge to form a slit of the appropriate size whereupon an actuator causes a ram assembly to deposit the coolant material within the cavity.

There is no disclosure of a means of extracting the meat itself nor of applying a vacuum or compressed fluid to the tool tip.

CA 1,171,690 Centre De Recherche Industrielle Du Quebec: A device for sampling meat is disclosed comprising a retractable hand-held pointer which uses a tubular serrated cutting edge in combination with a removable head piece to aid in retaining the sampled material. However, there is no disclosure of an aid to dislodge the retrieved sample from the sampling device, nor of the inclusion of any fluid/liquid lines to the tool head.

U.S. Pat. No. 5,433,121 Torra et al: Torra discloses a drill bit which includes a hollow cavity behind the cutting bit which meat/tissue samples may be retained. Torra further discloses a means of opening and closing the sample cavity via interlocking sleeves and the like. However, the mechanical configuration of the device is complex and does not lend itself to rapid sampling.

Japanese Patent Abstract No. 2-306164 Nichiee Yoshida K K: The abstract discloses a coring apparatus for use with frozen fish bodies. The inventive aspect appears to relate to the use of elastic pawl leavers which fixes the apparatus to the fish body. However, there is no disclosure of a means of enhancing the extraction/ejection of the sample.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a sampling tool including a tool head with a sample retaining portion characterised in that said sampling tool further includes a fluid conduit extending from the sample-retaining portion through the tool head.

As used herein, the term ‘fluid’ is defined to encompass both liquids and gases and any combination of both.

The term ‘sample’ includes any material extracted from a larger volume of the test material, including, but not limited to, organic material such as meat, cheese, and the like.

Preferably, said tool further includes an elevated pressure mechanism capable of applying fluid to the tool head via said fluid conduit at an elevated pressure with respect to an environmental pressure external to, and surrounding said tool.

In a preferred embodiment, said elevated pressure is applied via a compressed gas. In practice, this is most likely to take the convenient form of compressed air for use with the tool in an un-pressurised environment at normal atmospheric pressure. It is possible however, that a liquid may be employed as well as or instead of a gas. The liquid may be used as a lubricant to help release the sample from the sample-retaining portion, and/or to aid in the cleaning/hygiene of the tool between samples.

Said elevated pressure mechanism may either be an external source connectable to said sampling tool, or configured as an integral part of the sample tool, e.g. as a compressed air canister.

Preferably, application of said elevated pressure fluid is user-controllable.

Thus, after a user has retrieved a sample using the tool, the sample may be readily expelled from the sample-retaining portion by application of the elevated pressure fluid.

In one embodiment, said user controllable application is via a control such as an on/off control, preferably located on a handle portion of said tool. Naturally, the on/off control may be located in alternative locations, though an ergonomically advantageous position close to the user's hand/fingers on the handle will benefit efficiency and practicality.

The increased pressure applied (via the fluid) to the sample-retaining portion causes the sample to be ejected without need for further intervention from the user, either manually or using implements of some form such as tweezers.

It has been found that the presence of any small air pocket in the sample-retaining portion can cause an abnormally vigorous ejection of the sample when the compressed air (for example) is applied. The air pocket may become trapped during the collection process when the sample does not fully fill the sample-receiving portion adjacent to the sample.

To overcome this issue, the sample requires to be fully seated within the sample retaining portion and this may be achieved by application of a reduced pressure or vacuum to the fluid conduit during the sample collection process to remove any trapped air and to seat the sample in the sampler-retaining portion. The application of a reduced pressure or vacuum also has the benefit of ensuring a consistent sample size is obtained.

Thus, according to a further aspect of the present invention, said tool further includes a pressure reduction mechanism capable of applying to said sample retaining portion a reduced pressure with respect to said environmental pressure. Preferably, said reduced pressure is applied by a vacuum source.

According to one embodiment said reduced pressure is applied via a conduit at least partially distinct from said fluid conduit, though in an alternative embodiment, the tool may be configured with a distinct fluid conduit for said reduced pressure.

In a preferred embodiment, application of said reduced pressure is user-controllable, preferably via a control (e.g. an on/off control) located on a handle portion of said tool. The control may be conveniently combined with the elevated pressure control in a three-way control, i.e. high pressure, low pressure, off. Furthermore, the control need not be a simple on/off control and may incorporate additional features such as semi-automatic and/or remote control activation, multi-stage opening or any other desired control mechanism.

It will be appreciated that the present invention is not restricted to a particular configuration of tool head, nor to a method of operating same. Indeed a variety of tool heads may be employed including but not limited to;
a conical tool, having a pointed penetrating tip, with a said sample-retaining portion formed from a hollow inner volume open at the base with a sharpened circumference,
a spade/chisel shaped tool, with a sample-retaining portion formed from a opening on a reverse aspect to a cutting/sharpened edge of said spade/chisel shape;
a screw or auger-shaped tool with a hollow void forming said sample-retaining portion;
a pair of opposed cutting surfaces, with a sample retaining portion formed within one of said opposed surfaces. Said opposed cutting surfaces may be configured as scissor-action arms; a cutter and anvil, or a guillotine and/or any other appropriate means.

According to a further aspect of the present invention there is provided a method of obtaining a sample using a sampling tool including a tool head with a sample retaining portion and a fluid conduit extending from the sample-retaining portion through the tool head, the said method including the steps of
inserting said tool head into a test material;
withdrawing said tool head together with a sample of said material retained in said sample retaining portion;
   characterised in that;
an elevated pressure is applied via said fluid conduit to said sample-retaining portion to expel said sample.

Preferably, said method further includes the step of applying a reduced pressure to said sample-retaining portion after said sample has been retrieved and before application of said elevated pressure.

In embodiments using a scissor-type design, samples may be obtained in test materials in environments with floating detritus or other undesirable materials without contaminating the extracted sample. This may be achieved by closing the scissor jaws prior to immersion in the fluid/slurry containing said floating contaminants, and only opening the jaws to extract the sample from the test material below the surface. Such applications may include the extraction of samples from industrial waste such as wood pulp waste or sewerage, where it is desirable to avoid the inclusion of floating surface scum from contaminating the sample obtained.

In any of the above configurations, application of the elevated pressure to the sample-retaining portion will aid the hygienic and rapid extract of the sample with minimal user intervention.

### BRIEF DESCRIPTION OF DRAWINGS

Further aspects of the present invention will become apparent from the following description which is given by way of example only and with reference to the accompanying drawings in which:

FIG. 1 shows a schematic side elevation partial section of a sampling tool according to first embodiment of the present invention;

FIG. 2 shows the sampling tool shown in FIG. 1, inserted into a sample volume;

FIG. 3 shows the sampling tool shown in FIGS. 1-2 after withdrawal from the sample volume;

FIG. 4 shows a retrieved sample being expelled from said sample tool;

FIG. 5 shows a side elevation of a sampling tool according to a second preferred embodiment of the present invention, and

FIG. 6 shows the sampling tool shown in FIG. 5, inserted into a sample volume.

### BEST MODES FOR CARRYING OUT THE INVENTION

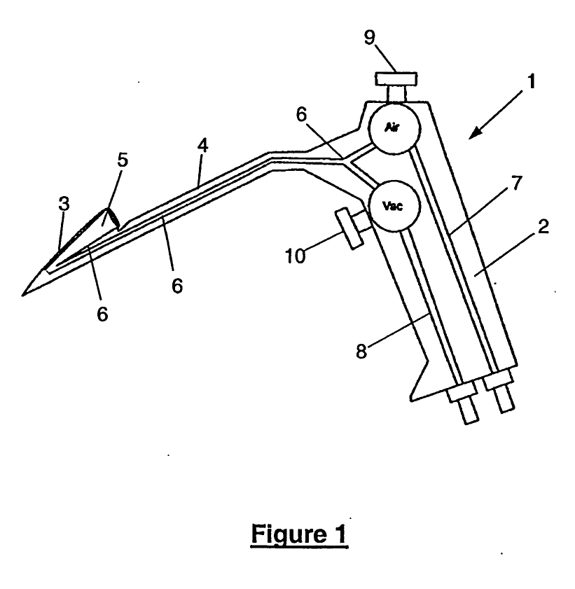

FIGS. 1-4 show a preferred embodiment of the present invention in the form of a sampling tool (1) comprised of a handle (2), attached to a tool head (3) via an elongated shaft (4).

In the embodiment shown, the tool head is a substantially hollow conical element open at the base to provide an inner recess of complementary conical shape to the exterior shape. The inner recess provides a sample-retaining portion (5) and is orientated to present the circular open base of hollow cone towards the elongated shaft (4) and away from the direction of insertion of the tool head (3) into a sample volume.

The sampling tool (1) further includes a fluid conduit (6) which extends from the sample-retaining portion (5) through the tool head (3), along the elongated shaft (4) to the handle (2). In the handle (2) the fluid conduit branches into two further conduits (7, 8) which are respectively connectable to separate external pressure source. An elevated pressure source in the form of a compressed air source (not shown) is connectable to one of the conduit branches (7), while a reduced pressure source in the form of a vacuum pump (not shown) is connectable to the other conduit branch (8).

The compressed air supply and vacuum conduits (7, 8) are both independently operable by the user through respective on/off switches (9, 10) located on the handle (2).

It will be appreciated alternative configurations are possible, including (by way of example only)
using an internal compressed air supply such as a pressurised canister instead of an external supply, or
optionally omitting the vacuum supply, associated conduit and switch (8, 10) and or
providing a variable control instead or the simple on/off controls (9,10).

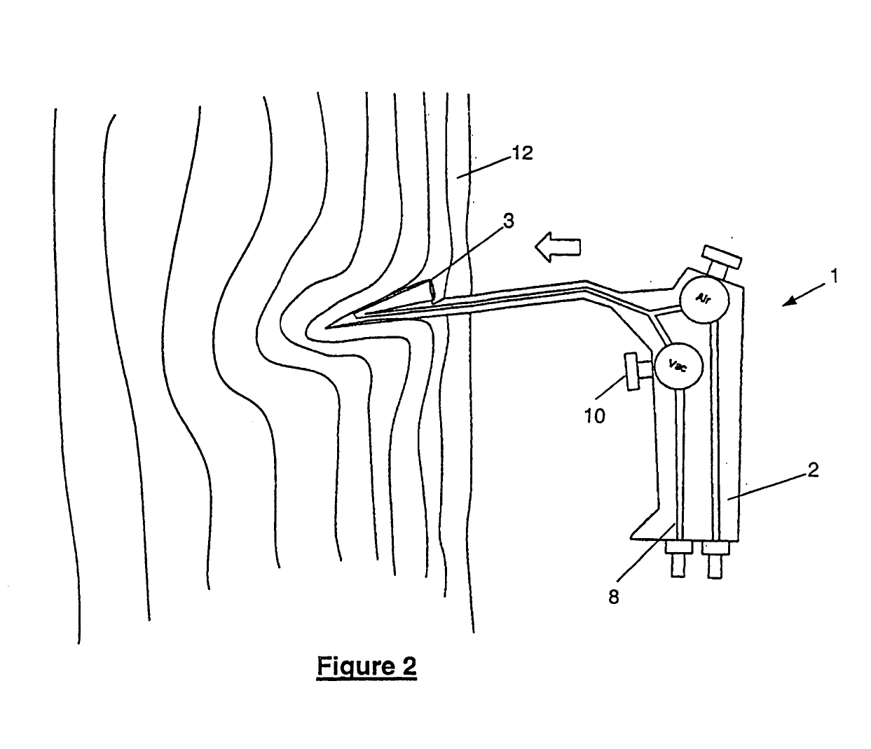

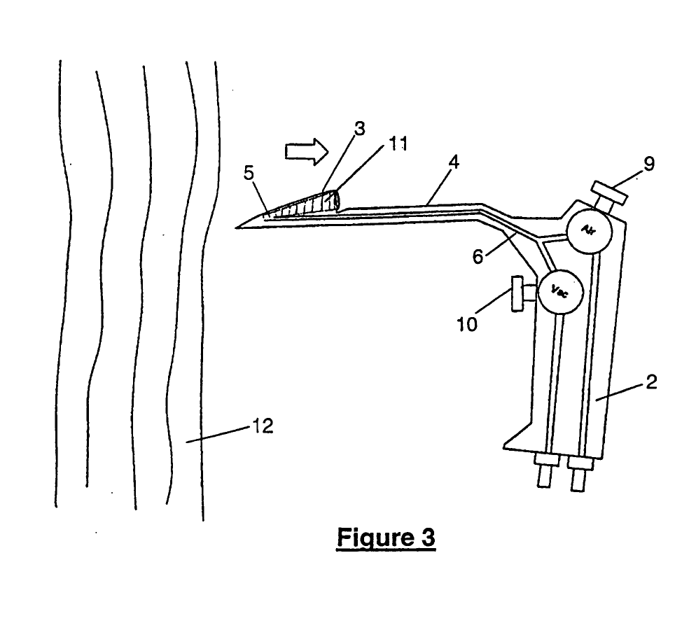

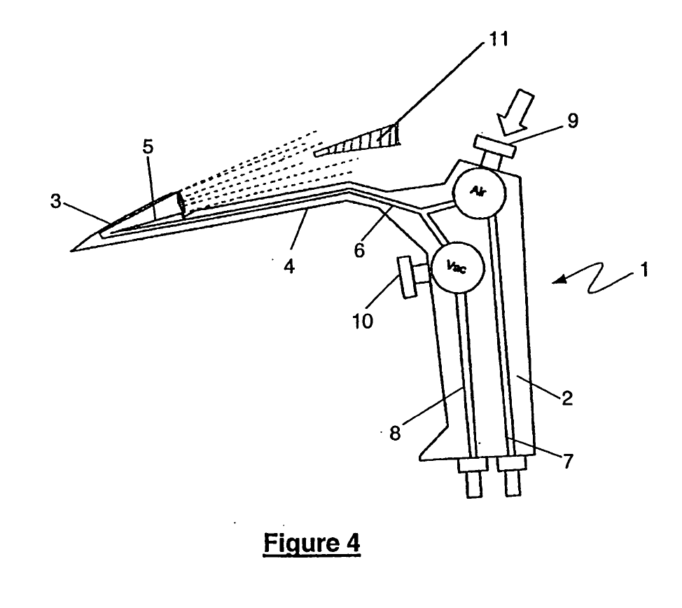

In use, the sampling tool (1) is used to obtain a small sample (11) (shown in FIGS. 3-4) of material from a larger volume of that material such as a block of meat (12). The conical configuration of the tool head (3) is typical of conventional sampling tools and utilises the pointed conical shape to permit ready insertion into the meat block (12), as shown in FIG. 2.

After the tool head (3) has been inserted to an appropriate depth, the user may then activate the vacuum switch (10) to apply a suction force to the sample (11), thereby eliminating any trapped air pockets and seating the sample (11) flush to the surfaces of the sample-retaining portion (5). The sampling tool (1) is then extracted on an approximately reciprocal path and in the process, the sharpened edge of the sample-retaining portion (5) cuts and retains a sample (11) from the meat block (12).

After removal of the tool head (3) clear from the meat block (12) (shown in FIG. 3), the user operates the switch (9) to apply compressed air to the sample-retaining portion (5) via the fluid conduits (6, 7).

The force applied to the sample (11) by the compressed air causes the sample (11) to be ejected (shown in FIG. 4) without being touched by the user. The process is thus rapid and without need for manual intervention to extract the retrieved sample from the tool head with fingers, tweezers, shaking the sample tool (1) or any other such activities. It will be appreciated that the present invention need not necessarily be restricted to sampling tools with the physical configuration or operating method described in the preferred embodiments, nor to the sampling of meat, or any other organic material.

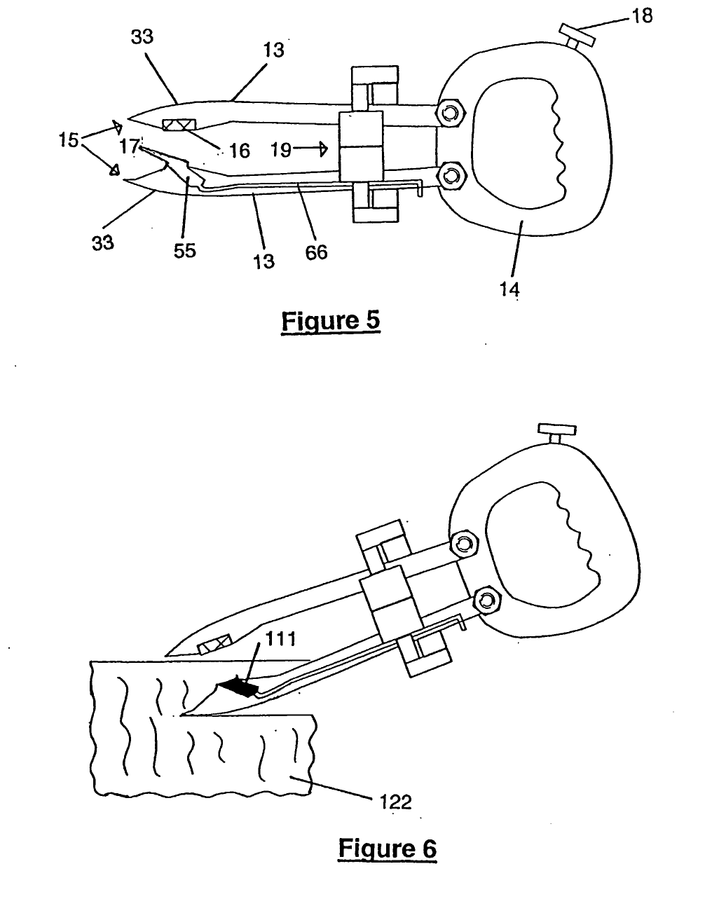

FIG. 5 shows an alternative embodiment in which the sampling tool (1) is configured in a scissor-type design comprised generally of two generally elongated jaws (13), both pivotally connected at one end to a common handle (14) with two tool heads (33) at the free distal ends (15) having generally opposing cutting surfaces in the form of an anvil surface (16) on one jaw (13) and a sample retaining portion (55) on the opposing jaw (13). The outer periphery of the sample-retaining portion (55) is formed with a raised lip (17) to provide a cutting action when pressed against the anvil (16).

The sample retaining portion (55) is also connected to an elevated pressure source (not shown) via a fluid conduit (66) extending through the elongated jaw (13). The opening and closing operation of the two jaws (13) is user-controlled by an on/off switch (18) located on the handle (14), operating the movement of a compressed air ram (19), mounted transversely between the two jaws.

In use (shown in FIG. 6), the pointed distal end of the jaw (13) containing the sample retaining portion (55) is inserted into the test sample (e.g. a block of meat (122), thereby filling the sample retaining portion (55) with a sample (111) of the meat (122). The operator then activates the ram (19) to close the jaws (13) thus bringing the raised lip (17) of the sample retaining portion (55) into contact with the anvil (16) to cleanly sever the sample (111) from the meat block (122).

The jaws (13) are then withdrawn from the meat (12) and the sample (11) is expelled from the tool (1) by the application of compressed air through the conduit (66), as described in the previous embodiment. Similarly, a vacuum may be applied to the sample retaining portion (55) to seat the sample (111) prior to removal to avoid an overly energetic ejection.

In sampling environments such as industrial waste, it may be desirable to ensure the sample is taken from material below the surface of a slurry/liquid to avoid contamination from undesirable floating matter. In such applications, the tool (1) may be inserted into the sample (122) with the jaws (13) in the closed position. The jaws (13) are then opened and the sample (111) obtained as described above, with the exception that the jaws (13) are held closed again until after removal from the contaminating environment.

Aspects of the present invention have been described by way of example only and it should be appreciated that modifications and additions may be made thereto without departing from the scope thereof.

1. A signal amplification method for detecting an expressed gene, wherein the detection sensitivity of the expressed gene on a DNA chip is improved by the use of a reverse transcription reaction and a self-assembly reaction forming a self-assembly substance by means of self-assembling of oligonucleotide probes.

2. A signal amplification method for detecting an expressed gene, wherein the detection sensitivity of the expressed gene on a DNA chip is improved by the use of a reverse transcription reaction and a self-assembly reaction forming a self-assembly substance by means of self-assembling of oligonucleotide probes, the signal amplification method comprising the steps of:
performing a reverse transcription reaction of mRNA using a first probe containing poly(dT) at the 3′ end and a region hybridizable with the oligonucleotide probe as a primer to form a second probe having a cDNA region;
separating the mRNA from the second probe;
hybridizing the second probe with a capture probe having a region complementary to a cDNA region of a target mRNA; and
forming a self-assembly substance by a self-assembly reaction using the second probe and the oligonucleotide probe.

3. The signal amplification method according to claim 1, wherein the self-assembly reaction is performed using a plurality of pairs of oligonucleotide probes, in which the number of base sequence regions complementary each other is n (n≧3), in such a manner that by hybridizing the oligonucleotide probes each other in alternation, the oligonucleotide probes are self-assembled to form a double-stranded self-assembly substance.

4. A signal amplification method for detecting an expressed gene, wherein the detection sensitivity of the expressed gene on a DNA chip is improved by the use of a reverse transcription reaction and a self-assembly reaction, wherein the self-assembly reaction is performed using a plurality of pairs of a first HCP and a second HCP of oligonucleotide probes, in which the number of base sequence regions complementary each other is n (n≧3), in such a manner that by hybridizing the oligonucleotide probes each other in alternation, the oligonucleotide probes are self-assembled to form a double-stranded self-assembly substance, the signal amplification method comprising the steps of:
binding a first probe containing poly(dT) at the 3′ end and at least a part of the base sequence regions of the first HCP to mRNA;
performing a reverse transcription reaction by a reverse transcriptase to form a second probe containing a cDNA region and at least a part of the base sequence regions of the first HCP;
removing the mRNA; thereafter
hybridizing the second probe with a capture probe having a region complementary to a cDNA region of a target mRNA; and
adding both the first HCP and the second HCP or adding the second HCP to form a self-assembly substance by the self-assembly reaction of the oligonucleotide probes so that signal amplification can be achieved.

5. The signal amplification method according to claim 1, wherein the self-assembly reaction comprises the steps of:
providing a first group and a second group,
the first group including a plurality of pairs of dimer-forming probes containing a pair of an oligonucleotide No. 1 and an oligonucleotide No. 2, each oligonucleotide having three regions of a 3′ side region, a mid-region and a 5′ side region, in which the mid-regions thereof have base sequence complementary to each other to form a dimer probe, and the 3′ side regions and the 5′ side regions thereof have base sequences not complementary to each other, and
the second group including a plurality of pairs of cross-linking probes containing a pair of an oligonucleotide No. 3 and an oligonucleotide No. 4, each oligonucleotide having two regions of a 3′ side region and a 5′ side region, in which the 3′ side regions and the 5′ side regions thereof have base sequences not complementary to each other, and the pairs of the cross-linking probes having base sequences capable of cross-linking the dimer probes formed from the dimer-forming probes; and
hybridizing the probes,
wherein the oligonucleotide probes are self-assembled to form the self-assembly substance.

6. The signal amplification method according to claim 5, wherein the base sequences of the probes are complementary to each other in the following respective pairs:,
the 3′ side region of the oligonucleotide No.1 in the first group and
the 3′ side region of the oligonucleotide No.3 in the second group;
the 5′ side region of the oligonucleotide No.2 in the first group and
the 5′ side region of the oligonucleotide No.4 in the second group;
the 3′ side region of the oligonucleotide No.4 in the second group and the 3′ side region of the oligonucleotide No.2 in the first group; and
the 5′ side region of the oligonucleotide No.3 in the second group and the 5′ side region of the oligonucleotide No.1 in the first group.

7. The signal amplification method according to claim 5, wherein the base sequences of the probes are complementary to each other in the following respective pairs:,
the 3′ side region of the oligonucleotide No.1 in the first group and
the 3′ side region of the oligonucleotide No.3 in the second group;
the 5′ side region of the oligonucleotide No.2 in the first group and
the 5′ side region of the oligonucleotide No.3 in the second group;
the 3′ side region of the oligonucleotide No.2 in the first group and
the 3′ side region of the oligonucleotide No.4 in the second group; and
the 5′ side region of the oligonucleotide No. 1 in the first group and
the 5′ side region of the oligonucleotide No.4 in the second group.

8. The signal amplification method according to claim 2, wherein the capture probe is bound to a support.

9. The signal amplification method according to claim 8, wherein the support is a microplate type, a slide glass type, a particle type, or an electroconductive substrate type.

10. The signal amplification method according to claim 1, further comprising hybridizing a labeled probe with the self-assembly substance to detect the presence of the self-assembly substance.

11. The signal amplification method according to claim 10, wherein the labeled probe is a probe labeled with an enzyme of color generation type, an enzyme of luminescence generation type or a radioisotope.

12. The signal amplification method according to claim 1, wherein the presence of the self-assembly substance is detected by:
adding a fluorescent substance capable of binding to a nucleic acid to the self-assembly substance; and
measuring a photochemical change of the fluorescent substance.

13. The signal amplification method according to claim 1, wherein the presence of the self-assembly substance is detected by:
labeling in advance at least one of the oligonucleotide probes forming the self-assembly substance with a fluorescent substance; and
measuring a photochemical change of the fluorescent substance.

14. The signal amplification method according to claim 1, wherein the presence of the self-assembly substance is detected by:
labeling in advance at least one of the oligonucleotide probes forming the self-assembly substance with a radioisotope; and
detecting the radioisotope.

15. The signal amplification method according to claim 1, wherein the presence of the self-assembly substance is detected by:
labeling in advance at least one of the oligonucleotide probes forming the self-assembly substance with an enzyme of color generation type or an enzyme of luminescence generation type; and
measuring a photochemical change due to the enzyme.

16. The signal amplification method according to claim 1, wherein the oligonucleotide probes are comprised of at least one base selected from the group consisting of DNA, RNA, PNA, and LNA.
